(19) United States
(12) Patent Application Publication
(10) Pub. No.: US 2021/0320486 A1
(43) Pub. Date: Oct. 14, 2021

(54) FIXING STRUCTURE FOR CORRUGATED TUBE AND FIXING METHOD FOR CORRUGATED TUBE

(71) Applicant: Yazaki Corporation, Tokyo (JP)

(72) Inventor: Ryota ISHIMITSU, Hiroshima-shi (JP)

(73) Assignee: Yazaki Corporation, Tokyo (JP)

(21) Appl. No.: 17/225,372

(22) Filed: Apr. 8, 2021

(30) Foreign Application Priority Data
Apr. 13, 2020 (JP) 2020-071567

(51) Int. Cl. H02G 3/30; H01B 7/00; H02G 3/04

(52) U.S. Cl. CPC H02G 3/30; H01B 7/0045; B60R 16/0215; H02G 3/0406; H02G 3/0468

(57) ABSTRACT

There are provided a fixing structure for corrugated tube and a fixing method for corrugated tube including a corrugated tube that is extensible and contractible in a longitudinal direction of the corrugated tube, and through which a wiring is inserted; and a plurality of fixing members configured to fix the corrugated tube through which the wiring is inserted to a plurality of fixing locations provided at a fixing destination, the fixing members being attached to an outer surface of the corrugated tube at a certain interval along the longitudinal direction. The corrugated tube is extended or contracted between adjacent fixing members of the plurality of fixing members, and the adjacent fixing members are adjusted to be at an interval corresponding to a different interval at which the plurality of fixing locations are arranged, such that the plurality of fixing members are fixed to the plurality of fixing locations.

### CROSS-REFERENCE TO RELATED APPLICATIONS

This application is based on and claims priority under 35 USC 119 from Japanese Patent Application No. 2020-071567 filed on Apr. 13, 2020, the contents of which are incorporated herein by reference.

### TECHNICAL FIELD

The present disclosure relates to a fixing structure for corrugated tube and a fixing method for corrugated tube for fixing a corrugated tube through which wiring is inserted.

### BACKGROUND ART

When wiring is applied to a vehicle or the like in the related art, a fixing member such as a clip attached to an exterior member of the wiring is fixed to a fixing location of a panel that is a fixing destination, thereby fixing the exterior member to the fixing destination.

For example, as shown in FIG. 4, JP2019-087432A describes a fixing structure for corrugated tube 100 in which a corrugated tube 200B is movably attached to an outer side of a corrugated tube 200A used as an exterior member of wiring, and clips 300 are attached to the movable outer corrugated tube 200B as fixing members.

In the fixing structure for corrugated tube 100 described in JP2019-087432A, even when a plurality of attachment holes P1, P2 of a panel P that is a fixing destination, to which the clips 300 are to be fixed, are arranged at different intervals, the clips 300 can be fixed to the plurality of attachment holes P1, P2 at different arrangement intervals.

More specifically, in the fixing structure for corrugated tube 100 described in JP2019-087432A, the outer corrugated tube 200B is attached to the inner corrugated tube 200A in accordance with the arrangement interval between the attachment holes P1, P2, thereby fixing the clips 300 to the plurality of attachment holes P1, P2 at different arrangement intervals.

However, in the fixing structure for corrugated tube described in JP2019-087432A, it is necessary to provide a corrugated tube that is movable to the outer side of the corrugated tube through which the wiring is inserted as a separate member, resulting in an increased number of components. As a result, component costs may increase.

### SUMMARY OF INVENTION

The present disclosure provides a fixing structure for corrugated tube and a fixing method for corrugated tube that can fix a corrugated tube to a fixing destination even when a plurality of fixing locations of the fixing destination are arranged at different intervals while reducing component costs.

According to an aspect of the present disclosure, a fixing structure for corrugated tube includes: a corrugated tube that is extensible and contractible in a longitudinal direction of the corrugated tube, and through which a wiring is inserted; and a plurality of fixing members configured to fix the corrugated tube through which the wiring is inserted to a plurality of fixing locations provided at a fixing destination, the fixing members being attached to an outer surface of the corrugated tube at a certain interval along the longitudinal direction. The corrugated tube is extended or contracted between adjacent fixing members of the plurality of fixing members, and the adjacent fixing members are adjusted to be at an interval corresponding to a different interval at which the plurality of fixing locations are arranged, such that the plurality of fixing members are fixed to the plurality of fixing locations.

According to another aspect of the present disclosure, a fixing method for corrugated tube includes: attaching a plurality of fixing members to an outer surface of a corrugated tube at a certain interval along a longitudinal direction of the corrugated tube, the plurality of fixing members being configured to fix the corrugated tube through which a wiring is inserted to a plurality of fixing locations provided at a fixing destination; and fixing the plurality of fixing members to the plurality of fixing locations by extending or contracting the corrugated tube between adjacent fixing members of the plurality of fixing members, and by adjusting the adjacent fixing members to be at an interval corresponding to a different interval at which the plurality of fixing locations are arranged.

### BRIEF DESCRIPTION OF DRAWINGS

FIGS. 1A and 1B show a fixing structure for corrugated tube according to an embodiment of the present disclosure, in which FIG. 1A shows the fixing structure for corrugated tube when an arrangement interval between two attachment holes of a panel is substantially equal to an arrangement interval between two fixing members fixed to a corrugated tube, and FIG. 1B shows the fixing structure for corrugated tube when the arrangement interval between the two attachment holes of the panel is larger than the arrangement interval between the two attachment holes of the panel shown in FIG. 1A;

FIGS. 2A and 2B correspond to the fixing structure for corrugated tube shown in FIGS. 1A and 1B, and show a state before the two fixing members of the corrugated tube are fixed to the corresponding two attachment holes of the panel;

FIG. 3A is a cross-sectional view of a part of the corrugated tube shown in FIGS. 1A and 2A, and FIG. 3B is a cross-sectional view of a part of the corrugated tube shown in FIGS. 1B and 2B; and

FIG. 4 is a view of illustrating the related art.

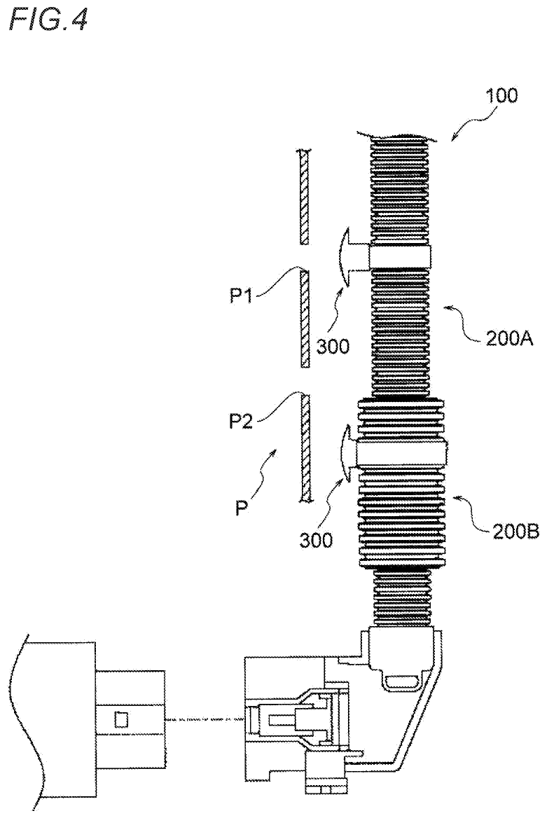

### DESCRIPTION OF EMBODIMENTS

Hereinafter, a preferred embodiment of a fixing structure for corrugated tube and a fixing method for corrugated tube according to the present disclosure will be described in detail with reference to the drawings.

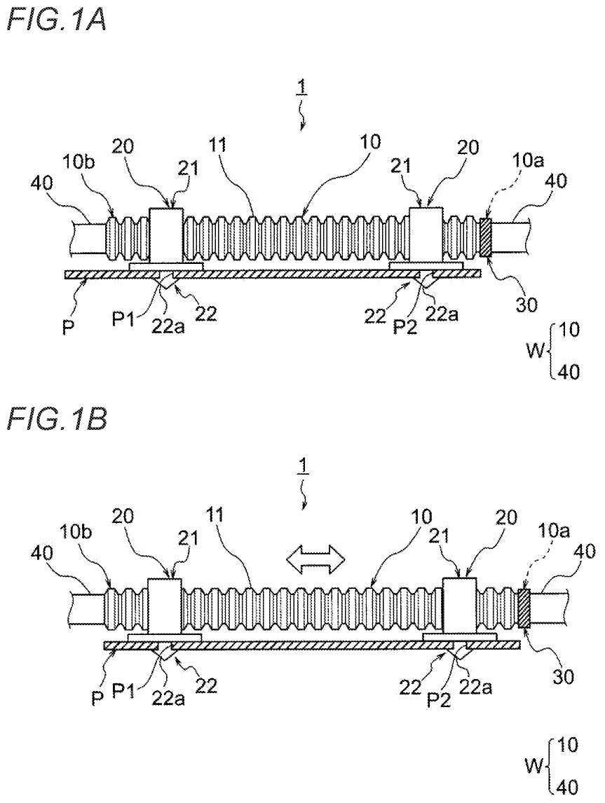

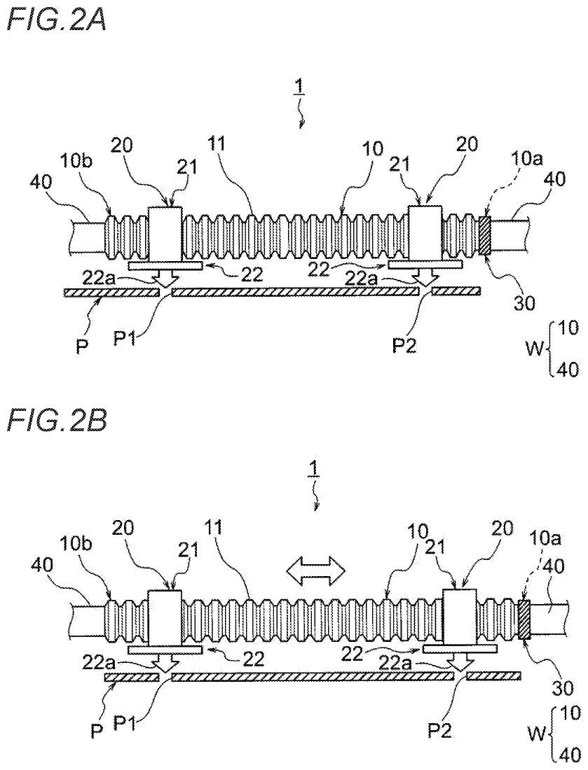

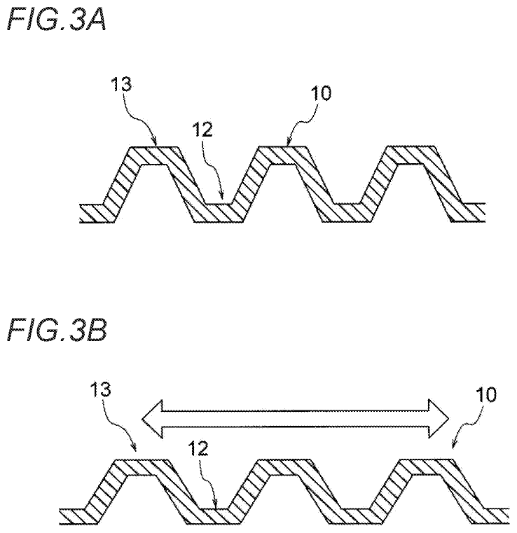

FIGS. 1A and 1B show a fixing structure for corrugated tube 1 according to an embodiment of the present disclosure, in which FIG. 1A shows the fixing structure for corrugated tube 1 when an arrangement interval between two attachment holes P1, P2 of a panel P is substantially equal to an arrangement interval between two fixing members 20, 20 fixed to a corrugated tube 10, and FIG. 1B shows the fixing structure for corrugated tube 1 when the arrangement interval between the two attachment holes P1, P2 of the panel P is larger than the arrangement interval between the two attachment holes P1, P2 of the panel P shown in FIG. 1A. FIGS. 2A and 2B correspond to the fixing structure for corrugated tube 1 shown in FIGS. 1A and 1B, and show a state before the two fixing members 20, 20 of the corrugated tube 10 are fixed to the corresponding two attachment holes P1, P2 of the panel P. FIG. 3A is a cross-sectional view of a part of the corrugated tube 10 shown in FIGS. 1A and 2A, and FIG. 3B is a cross-sectional view of a part of the corrugated tube 10 shown in FIGS. 1B and 2B.

The fixing structure for corrugated tube 1 and a fixing method for corrugated tube according to the embodiment of the present disclosure are used, for example, when a wire harness W is routed in a vehicle, and are used to fix the fixing members 20 attached to the corrugated tube 10, through which wiring 40 is inserted, to a plurality of fixing locations P1, P2 of the panel P that is a fixing destination.

The wire harness W includes the wiring 40 and the corrugated tube 10 that is an exterior member of the wiring 40.

Further, in the embodiment, the fixing locations P1, P2 of the panel P are the attachment holes P1, P2 to which fixing portions 22 of the fixing members 20, which will be described later, are fixed.

In the fixing structure for corrugated tube 1 according to the embodiment, two fixing members 20 corresponding to the two attachment holes P1, P2 of the panel P are attached to the corrugated tube 10, and the number of the fixing members 20 is not limited to two. That is, in the fixing structure for corrugated tube 1, a plurality of fixing members 20 may be provided corresponding to the plurality of attachment holes P1, P2 formed in the panel P.

The fixing structure for corrugated tube 1 includes: the corrugated tube 10 that is extensible and contractible in a longitudinal direction and through which the wiring 40 is inserted; a tube one-end-side fixing member 30 that fixes one end portion 10a of the corrugated tube 10, through which the wiring 40 is inserted, to the wiring 40 drawn out of a one end portion 10a side; and the two fixing members 20 that fix the corrugated tube 10, through which the wiring 40 is inserted, to the two attachment holes P1, P2 provided in the panel P that is a fixing destination and are attached to an outer surface 11 of the corrugated tube 10 at an interval in the longitudinal direction.

The corrugated tube 10 is a tube generally used as an exterior member of the wiring 40 of the wire harness W. As shown in FIG. 3, the corrugated tube 10 includes concave portions 12 and convex portions 13 that alternately repeat in the longitudinal direction.

The corrugated tube 10 is formed with a slit (not shown), and the wiring 40 can be inserted through the corrugated tube 10 by disposing the wiring 40 in the slit.

The corrugated tube 10 may not be formed with the slit.

The tube one-end-side fixing member 30 is an adhesive tape wound around the one end portion 10a of the corrugated tube 10 to cover the wiring 40.

The tube one-end-side fixing member 30 may be a member other than an adhesive tape as long as the one end portion 10a of the corrugated tube 10 through which the wiring 40 is inserted can be fixed to the wiring 40 drawn out of the one end portion 10a side. For example, the tube one-end-side fixing member 30 may be a binding band.

Each of the fixing members 20 includes a band portion 21 that is wound around and fixed to the outer surface 11 of the corrugated tube 10, and the fixing portion 22 that is fixed to a corresponding one of the attachment holes P1, P2 formed in the panel P.

The band portion 21 is fixed to the outer surface 11 of the corrugated tube 10 to be not movable in the longitudinal direction of the corrugated tube 10.

The fixing portion 22 includes a locking portion 22a having a triangular cross section and configured to be locked through the attachment holes P1, P2 to a surface of the panel P that is opposite to a surface of the panel P on a side where the corrugated tube 10 is attached.

In such a fixing structure for corrugated tube 1, the corrugated tube 10 is extensible and contractible between adjacent fixing members 20 of the two fixing members 20, thereby adjusting the adjacent fixing members 20, 20 to be at an interval corresponding to different arrangement intervals between the two attachment holes P1, P2.

More specifically, for example, the arrangement interval between the two attachment holes P1, P2 of the panel P shown in FIGS. 1A and 2A is substantially equal to the arrangement interval between the two fixing members 20, 20 fixed to the corrugated tube 10.

When the arrangement interval between the two fixing members 20, 20 is equal to the arrangement interval between the two attachment holes P1, P2, the fixing structure for corrugated tube 1 fixes the fixing members 20, 20 to the corresponding attachment holes P1, P2 without extending or contracting the corrugated tube 10 between the two fixing members 20, 20.

On the other hand, FIGS. 1B and 2B show the panel P in which the arrangement interval between the two attachment holes P1, P2 is different from the arrangement interval between the two attachment holes P1, P2 of the panel P shown in FIGS. 1A and 2A.

More specifically, the arrangement interval between the two attachment holes P1, P2 of the panel P shown in FIG. 1B and FIG. 2B is larger than the arrangement interval between the two attachment holes P1, P2 of the panel P shown in FIG. 1A and FIG. 2A.

In this way, when the arrangement interval between the two attachment holes P1, P2 is larger than the arrangement interval between the two fixing members 20, 20, the fixing structure for corrugated tube 1 can fix the two fixing members 20, 20 to the corresponding attachment holes P1, P2 by extending the corrugated tube 10 between the two fixing members 20, 20 and adjusting the arrangement interval between the two fixing members 20, 20 to a length corresponding to the arrangement interval between the two attachment holes P1, P2.

Next, the fixing method for corrugated tube according to the embodiment of the present disclosure will be described.

First, an operator inserts the wiring 40 into the corrugated tube 10.

In this operation, the operator disposes the wiring 40 in the corrugated tube 10 through the slit of the corrugated tube 10.

Thereafter, the operator fixes the one end portion 10a of the corrugated tube 10 through which the wiring 40 is inserted to the wiring 40 drawn out of the one end portion 10a side.

In this operation, the operator winds the adhesive tape 30 serving as the tube one-end-side fixing member 30 around the one end portion 10a of the corrugated tube 10 to cover the wiring 40.

By this operation, the corrugated tube 10 is brought into a state in which the one end portion 10a side is fixed to the wiring 40 and the other end portion 10b side is freely movable relative to the wiring 40.

For this reason, it is possible to easily position the corrugated tube 10 including the wiring 40 when the corrugated tube 10 is attached to the panel P.

Thereafter, the operator attaches the two fixing members 20, 20 to the outer surface of the corrugated tube 10 at an interval in the longitudinal direction of the corrugated tube.

In this operation, the operator fixes the band portion of each fixing member to the outer surface 11 of the corrugated tube.

Attachment positions of the two fixing members 20, 20 relative to the corrugated tube 10 may be determined in consideration of the arrangement interval of the plurality of attachment holes P1, P2 of different panels P to which the two fixing members 20, 20 are to be applied and an amount of extension and contraction of the corrugated tube 10.

Finally, the operator extends or contracts the corrugated tube 10 between the adjacent fixing members 20, 20 of the two fixing members 20, 20, and adjusts the two fixing members 20, 20 to be at the interval corresponding to the different arrangement intervals of the two attachment holes P1, P2, thereby fixing the two fixing members 20, 20 to the two attachment holes P1, P2.

More specifically, in this operation, as shown in FIG. 2A, when the arrangement interval between the two attachment holes P1, P2 is substantially equal to the arrangement interval between the two fixing members 20, 20 fixed to the corrugated tube 10, the operator fixes the fixing members 20, 20 to the corresponding attachment holes P1, P2 without extending or contracting the corrugated tube 10 between the two fixing members 20, 20.

On the other hand, when the arrangement interval of the attachment holes P1, P2 of the panel P is larger than the arrangement interval of the attachment holes P1, P2 of the panel P shown in FIG. 2A (see FIG. 2B), the corrugated tube 10 is extended between the two fixing members 20, 20 so that the two fixing members 20, 20 can be fixed to the corresponding attachment holes P1, P2.

In the fixing structure for corrugated tube 1 according to the embodiment of the present disclosure, the fixing structure 1 includes a corrugated tube 10 that is extensible and contractible in a longitudinal direction of the corrugated tube 10, and through which a wiring 40 is inserted; and a plurality of fixing members 20, 20 configured to fix the corrugated tube 10 through which the wiring 40 is inserted to a plurality of fixing locations P1, P2 provided at a fixing destination, the fixing members 20, 20 being attached to an outer surface of the corrugated tube 10 at a certain interval along the longitudinal direction. The corrugated tube 10 is extended or contracted between the adjacent fixing members 20, 20 of the plurality of fixing members 20, 20, and the adjacent fixing members 20, 20 are adjusted to be at an interval corresponding to a different interval at which the plurality of fixing locations P1, P2 are arranged, such that the plurality of fixing members 20, 20 are fixed to the plurality of fixing locations P1, P2.

Therefore, in the fixing structure for corrugated tube 1 according to the embodiment of the present disclosure, the corrugated tube 10 can be fixed to the panel P that is a fixing destination without providing a corrugated tube separate from the corrugated tube 10 through which the wiring 40 is inserted. Accordingly, it is possible to fix the corrugated tube 10 to the fixing destination P even when the plurality of fixing locations P1, P2 of the fixing destination P are arranged at different intervals while reducing component costs.

Since the fixing structure for corrugated tube 1 according to the embodiment of the present disclosure further includes the tube one-end-side fixing member 30 that fixes the one end portion 10a of the corrugated tube 10 through which the wiring 40 is inserted to the wiring 40 drawn out of a side of the one end portion 10a, it is possible to easily position the corrugated tube 10 including the wiring 40 when the corrugated tube 10 is attached to the panel P.

In the fixing structure for corrugated tube 1 according to the embodiment of the present disclosure, since the tube one-end-side fixing member 30 is an adhesive tape wound around the one end portion 10a to cover the wiring 40, the one end portion 10a of the corrugated tube 10 can be easily fixed to the wiring 40.

In the fixing method for corrugated tube according to the embodiment of the present disclosure, the fixing method for corrugated tube includes: attaching a plurality of fixing members 20, 20 to an outer surface of a corrugated tube 10 at a certain interval along a longitudinal direction of the corrugated tube 10, the plurality of fixing members 20, 20 being configured to fix the corrugated tube 10 through which a wiring 40 is inserted to a plurality of fixing locations P1, P2 provided at a fixing destination; and fixing the plurality of fixing members 20, 20 to the plurality of fixing locations P1, P1 by extending or contracting the corrugated tube 10 between adjacent fixing members 20, 20 of the plurality of fixing members 20, 20, and by adjusting the adjacent fixing members 20, 20 to be at an interval corresponding to a different interval at which the plurality of fixing locations P1, P2 are arranged.

Therefore, in the fixing method for corrugated tube according to the embodiment of the present disclosure, the corrugated tube 10 can be fixed to the panel P that is a fixing destination without providing a corrugated tube separate from the corrugated tube 10 through which the wiring 40 is inserted. Accordingly, it is possible to fix the corrugated tube 10 to the fixing destination P even when the plurality of fixing locations P1, P2 of the fixing destination P are arranged at different intervals while reducing component costs.

Since the fixing method for corrugated tube according to the embodiment of the present disclosure includes fixing the one end portion 10a of the corrugated tube 10 through which the wiring 40 is inserted to the wiring 40 drawn out of a side of the one end portion 10a before fixing the plurality of fixing members 20, 20 to the plurality of fixing locations P1, P2, it is possible to easily position the corrugated tube 10 including the wiring 40 when the corrugated tube 10 is attached to the panel P.

In the fixing structure for corrugated tube and the fixing method for corrugated tube according to the embodiment of the present disclosure, the one end portion 10a of the corrugated tube 10 is fixed to the wiring 40 by the tube one-end-side fixing member 30. However, in addition to the one end portion 10a side, the other end portion 10b side may be fixed to the wiring 40 using a member similar to the tube one-end-side fixing member 30. When the other end portion 10b side is fixed to the wiring 40 using a member similar to the tube one-end-side fixing member 30, the fixing method for corrugated tube may be such that the other end portion 10b side is fixed to the wiring 40 using the member similar to the tube one-end-side fixing member 30 after the plurality of fixing members 20, 20 are fixed to the corresponding attachment holes P1, P2.

The fixing structure for corrugated tube and the fixing method for corrugated tube according to the embodiment of the present disclosure provided the panels P different in the arrangement interval between the plurality of attachment holes P1, P2. However, the fixing structure for corrugated tube and the fixing method for corrugated tube according to the present disclosure can also be used when the arrangement intervals between the plurality of attachment holes P1, P2 are different on the same panel P.

For example, the fixing structure for corrugated tube and the fixing method for corrugated tube according to the present disclosure can also be used even when three attachment holes are formed in the same panel P and arrangement intervals from the two attachment holes on both end sides in an arrangement direction to the one attachment hole arranged therebetween are different from each other.

The fixing structure for corrugated tube and the fixing method for corrugated tube according to the embodiment of the present disclosure are used when the wiring 40 is routed in a vehicle. However, the fixing structure for corrugated tube and the fixing method for corrugated tube according to the embodiment of the present disclosure may also be used when the wiring 40 is routed in a target other than a vehicle.

In the fixing structure for corrugated tube and the fixing method for corrugated tube according to the embodiment of the present disclosure, the fixing locations of the fixing members 20, 20 are the attachment holes P1, P2 formed in the panel P, and the fixing locations of the fixing members 20, 20 are not limited to hole-shaped locations.

That is, the fixing locations may have a structure other than a hole as long as the fixing members can be fixed to the fixing locations. When the fixing locations have a structure other than a hole, the fixing members may have a structure that can be fixed to the fixing locations other than a hole instead of the fixing members shown in the embodiment.

In the fixing structure for corrugated tube and the fixing method for corrugated tube according to the embodiment of the present disclosure, the corrugated tube 10 is extended between the adjacent fixing members 20, 20 of the plurality of fixing members 20, 20. However, the arrangement interval between the adjacent fixing members 20, 20 is not limited to being adjusted by extending the corrugated tube 10 between the adjacent fixing members 20, 20.

That is, in the fixing structure for corrugated tube and the fixing method for corrugated tube according to the embodiment of the present disclosure, the arrangement interval between the adjacent fixing members 20, 20 may be adjusted by contracting the corrugated tube 10 between the adjacent fixing members 20, 20 of the plurality of fixing members 20, 20.

Although the present disclosure made by the present inventors has been specifically described based on the embodiment of the present disclosure described above, the present disclosure is not limited to the embodiment of the present disclosure described above, and various modifications can be made without departing from the scope of the present disclosure.

In the fixing structure for corrugated tube according to the present disclosure, the corrugated tube is extended or contracted between adjacent fixing members of the plurality of fixing members, and the adjacent fixing members are adjusted to be at an interval corresponding to different arrangement intervals of the plurality of fixing locations, so that the plurality of fixing members are fixed to the plurality of fixing locations.

Therefore, in the fixing structure for corrugated tube according to the present disclosure, the corrugated tube can be fixed to the fixing destination without providing a corrugated tube separate from the corrugated tube through which the wiring is inserted. Accordingly, it is possible to fix the corrugated tube to the fixing destination even when the plurality of fixing locations of the fixing destination P are arranged at different intervals while reducing component costs.

In the fixing method for corrugated tube according to the present disclosure, the corrugated tube is extended and contracted between adjacent fixing members of the plurality of fixing members, and the adjacent fixing members are adjusted to be at an interval corresponding to different arrangement intervals of the plurality of fixing locations, so that the plurality of fixing members are fixed to the plurality of fixing locations.

Therefore, in the fixing method for corrugated tube according to the present disclosure, the corrugated tube can be fixed to the fixing destination without providing a corrugated tube separate from the corrugated tube through which the wiring is inserted. Accordingly, it is possible to fix the corrugated tube to the fixing destination even when the plurality of fixing locations of the fixing destination P are arranged at different intervals while reducing component costs.

What is claimed is:

1. A fixing structure for corrugated tube comprising:
a corrugated tube that is extensible and contractible in a longitudinal direction of the corrugated tube, and through which a wiring is inserted; and
a plurality of fixing members configured to fix the corrugated tube through which the wiring is inserted to a plurality of fixing locations provided at a fixing destination, the fixing members being attached to an outer surface of the corrugated tube at a certain interval along the longitudinal direction,
wherein the corrugated tube is extended or contracted between adjacent fixing members of the plurality of fixing members, and the adjacent fixing members are adjusted to be at an interval corresponding to a different interval at which the plurality of fixing locations are arranged, such that the plurality of fixing members are fixed to the plurality of fixing locations.

2. The fixing structure for corrugated tube according to claim 1, further comprising:
a tube one-end-side fixing member that fixes one end portion of the corrugated tube through which the wiring is inserted to the wiring drawn out of a side of the one end portion.

3. The fixing structure for corrugated tube according to claim 2,
wherein the tube one-end-side fixing member is an adhesive tape wound around the one end portion to cover the wiring.

4. A fixing method for corrugated tube comprising:
attaching a plurality of fixing members to an outer surface of a corrugated tube at a certain interval along a longitudinal direction of the corrugated tube, the plurality of fixing members being configured to fix the corrugated tube through which a wiring is inserted to a plurality of fixing locations provided at a fixing destination; and
fixing the plurality of fixing members to the plurality of fixing locations by extending or contracting the corrugated tube between adjacent fixing members of the plurality of fixing members, and by adjusting the adjacent fixing members to be at an interval corresponding to a different interval at which the plurality of fixing locations are arranged.

5. The fixing method for corrugated tube according to claim 4, further comprising:
before the fixing of the plurality of fixing members to the plurality of fixing locations, fixing one end portion of the corrugated tube through which the wiring is inserted to the wiring drawn out of a side of the one end portion.
